(19) United States
(12) Patent Application Publication
(10) Pub. No.: US 2016/0176646 A1
(43) Pub. Date: Jun. 23, 2016

(54) PORTABLE CONVEYOR BELT SYSTEM SUITABLE FOR INPSECTION OF OBJECTS

(71) Applicant: SATPAL SINGH, Potomac, MD (US)

(72) Inventor: SATPAL SINGH, Potomac, MD (US)

(21) Appl. No.: 14/581,929

(22) Filed: Dec. 23, 2014

(51) Int. Cl. B65G 41/00; G01N 23/02; B65G 15/28

(52) U.S. Cl. CPC B65G 41/00; B65G 15/28; G01N 23/02

(57) ABSTRACT

A portable conveyor belt that is easy to carry by hand has been presented. It can be used for inspection of packages in outdoor locations such as at sporting events, roadside check points and other temporary locations. The conveyor belt can be quickly disassembled into smaller and lighter subsystems that are easier to carry by hand. Once transported to the desired location, it can be quickly assembled.

### BACKGROUND OF THE INVENTION

A portable conveyor belt system especially suited for inspection of packages using X-rays.

1. Description of the Related Art

Small conveyor belts are often used for inspection of packages, for example the x-ray scanners at the airport utilize a conveyor belt on which the bags are placed. As the conveyor belt moves, the bags are transported through a tunnel or a station or an enclosure where they get exposed to x-rays. These x-rays after passing through the bag are then detected and a scanned image is generated for inspection. These conveyor belt scanners are typically five to six feet long, five feet high, two and a half feet wide, weigh eight hundred to more than fifteen hundred pounds, and are therefore too heavy and big to be carried by hand to an outdoor location like a sporting event at a stadium or for roadside checkpoint use. The currently available small x-ray scanning systems, that can be hand carried, have a small imaging area and cannot be used for continuous scanning of a large number of bags. Using these hand held systems typically takes several tens of seconds to a few minutes to scan just one bag which is too slow for scanning large number of bags at an outdoor location. Therefore it would be desirable if conveyor belt type scanners could be made that are easily portable and can be hand carried.

The objects of this invention are therefore to overcome some of the above problems and are listed next.

2. Objects and Advantages of the Invention

It is, accordingly, an object of the invention to build a conveyor belt system that is easily portable and can be hand carried.

Another object of the present invention is that it can be used with an x-ray or a radiation source and a detection system for use as an easy to carry system especially suited for scanning large number of packages at an outdoor or a temporary location.

These and other objects will become apparent in the description that follows.

### SUMMARY OF THE INVENTION

In accordance with one embodiment, a portable conveyor belt is presented that is especially suited for x-ray inspection of packages. It comprises of a frame or multiple sections of a frame that can be easily assembled into a longer frame, further the frame supports a conveyor belt driven over a pair of rollers with one roller at each end of the frame. The frame is supported by easy to assemble and disassemble legs. Side panels are erected over the top of conveyor frame with an easy to attach and detach mechanisms. These side panels form side walls on the sides of the conveyor belt and above it. On top of these side panels, are mounted top panels with an easy to attach and detach mechanism. The ensemble of side and top panels form a tunnel like enclosure or an inspection station over the conveyor belt. An x-ray source, a set of detectors and associated electronics can be arranged around the tunnel and the conveyor belt to assemble an inspection system.

There are several embodiments, objects and advantages to this invention that will be apparent to one skilled in the art. The accompanying figures and description herein should be considered illustrative only and not limiting or restricting the scope of invention, the scope being indicated by the claims.

### BRIEF DESCRIPTION OF THE DRAWINGS

FIGS. 1A and 1B show two different views in accordance with one embodiment.

FIGS. 2A, 2B and 2C show the assembly of the conveyor frame and conveyor belt.

FIG. 3 shows the assembly of the inspection tunnel over the conveyor frame.

### DETAILED DESCRIPTION OF THE PREFERRED EMBODIMENTS

In describing the preferred embodiment and its alternatives, specific terminology will be used for the sake of clarity. However, the invention is not limited to the specific terms so used, and it should be understood that each specific term includes all its technical equivalents which operate in a similar manner to accomplish similar purpose.

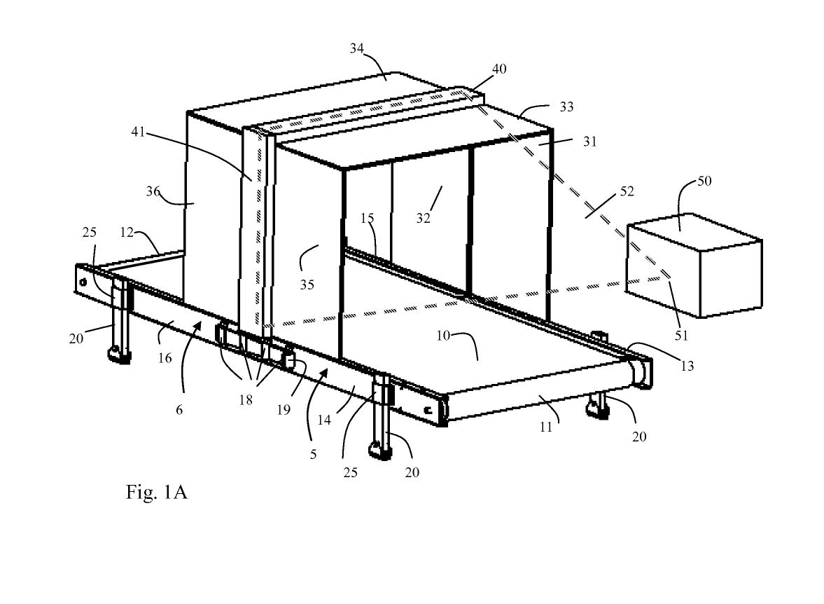

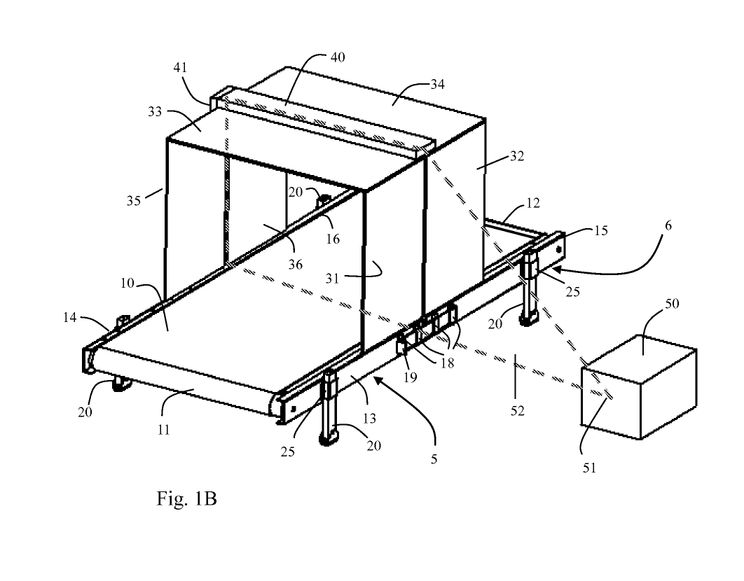

A simplified assembly of one embodiment is shown in two different views in FIGS. 1A and 1B. A conveyor belt 10 is shown driven over a first roller 11 and a second roller 12 supported by a conveyor frame comprising of two sections 5 and 6. Section 5 of conveyor frame comprises of side rails 13 and 14 and supports the roller 11, the section end supporting roller 11 is hereafter referred to as the first end of the conveyor frame. Section 6 of conveyor frame comprises of side rails 15 and 16 and supports the roller 12, and the section end supporting roller 12 is hereafter referred to as the second end of the conveyor frame. Side rails 13 and 15 constitute the first side or the right side of conveyor frame and rails 14 and 16 constitute the second side or the left side of conveyor frame. The two sections 5 and 6 of conveyor frame are held in place by a securing means on either side of the conveyor frame. This securing means comprises of a sliding bolt type of a mechanism comprising of sliding member 19 and brackets 18. The conveyor frame is supported by legs 20 that can be secured into holding brackets 25 on the side rails 13, 14, 15 and 16.

Removable right side panels 31 and 32 having top and bottom ends or sides and hereafter referred to as the right side panels are assembled adjacent to the right side of conveyor frame.

The bottom sides of panels 31 and 32 are secured to side rails 13 and 15 by a means that allows quick attachment and detachment. Removable left side panels 35 and 36 having top and bottom ends or sides and hereafter referred to as the left side panels are assembled adjacent to the left side of conveyor frame. The bottom sides of panels 35 and 36 are secured to side rails 14 and 16 by a means that allows quick attachment and detachment.

Removable top side panels 33 and 34 are positioned over side panels 31, 32, 35 and 36 as shown in FIGS. 1A and 1B. Removable top side panel 33 has a left side positioned adjacent to top side of left panel 35, and it further has a right side that is positioned adjacent to the top side of right side panel 31. Likewise, removable top side panel 34 has a left side positioned adjacent to top side of left panel 36, and it further has a right side that is positioned adjacent to the top side of right side panel 32. Top panel 33 is secured by a means that allows quick attachment and detachment to the top sides of panels 35 and 31. Likewise, Top panel 34 is secured by a means that allows quick attachment and detachment to the top sides of panels 32 and 36.

The assembly or the ensemble of side and top panels form a tunnel like enclosure or an inspection tunnel or an inspection station over the conveyor belt. The assembly of the panels is such that there is a small gap of the order of one inch or less between side panels 31 and 32, and between top panels 33 and 34, and between side panels 35 and 36. This gap allows for the passage of a radiation beam 52 emitted from a radiation source or the focal point 51 of an x-ray tube situated inside a generator box 50. The radiation beam 52 intersects the volume or space or the inspection tunnel enclosed by the side panels, the top panels and the conveyor belt 10. This radiation beam is detected by a detector comprising of detector boxes 40 and 41. The radiation beam 52 passing through the gap between top panels 33 and 34 hits the top detector box 40.

Likewise, the radiation beam 52 passes through the gap between side panels 35 and 36 hits the side detector box 41. The radiation or signal detected by detector boxes 40 and 41 is converted to electronic signal that is processed by electronics means and displayed on a screen as a scanned image. The panels 33, 34, 35 and 36 are usually lined with lead to contain the x-ray radiation within the inspection tunnel formed within the space enclosed by these panels. Various other electronic and mechanical details of the system have been omitted to avoid the clutter but well understood by a person skilled in the art.

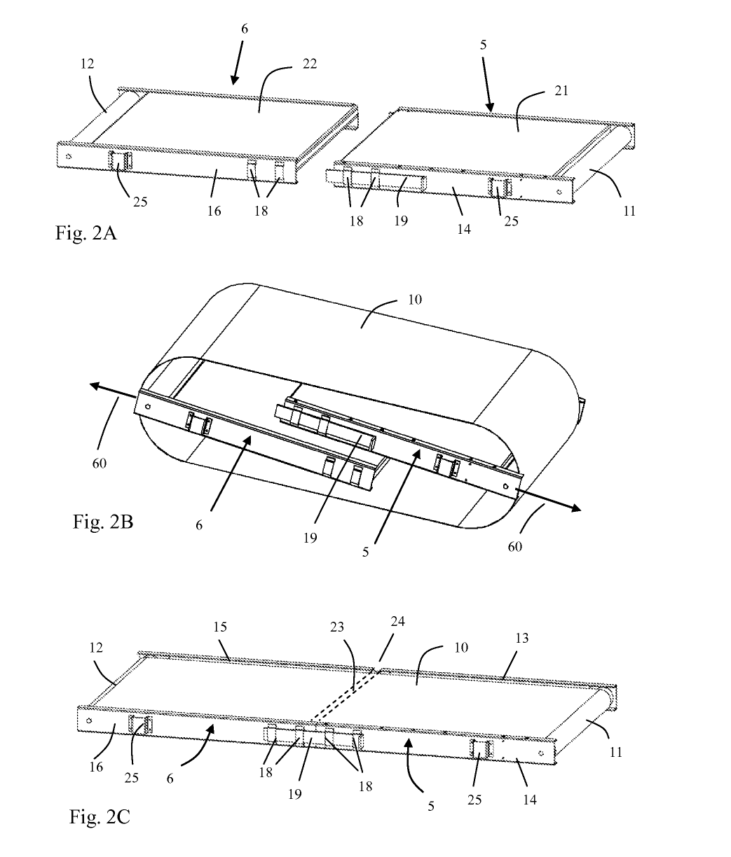

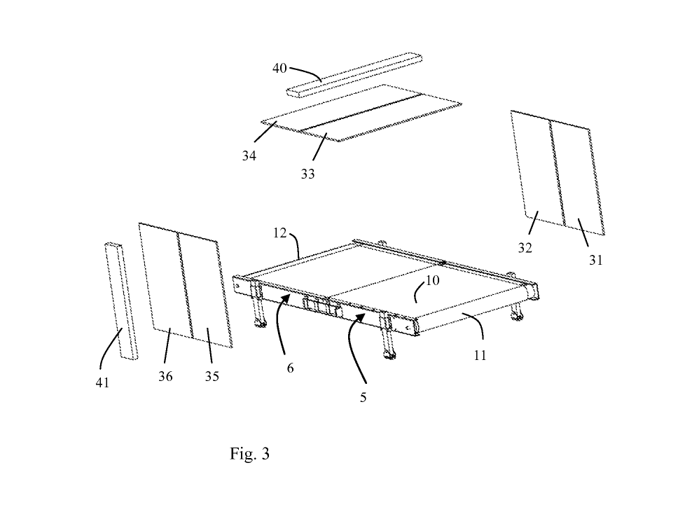

The conveyor system as described above allows for breaking down or disassembly of a larger and heavier system into smaller subsystems or parts that are easier to transport and can be hand carried. These smaller subsystems and their assembly is further illustrated in FIGS. 2A, 2B and 2C.

FIG. 2A shows the two sections 5 and 6 of the conveyor frame brought close together and ready to be assembled. 21 and 22 are rigid panels that separate the side rails of section 5 and 6 respectively. They comprise the bed or the top side of the conveyor frame over which the conveyor belt 10 slides. The side opposite the top side of conveyor frame is hereafter referred to as the underside. Next the two sections 5 and 6 are arranged as shown in FIG. 2B and the conveyor belt 10 is slipped over them. The two sections 5 and 6 are then pulled apart in the direction indicated by arrows 60 shown in FIG. 2B. As the two sections 5 and 6 are pulled apart, they are aligned and secured together by sliding member 19 into brackets 18 as shown in FIG. 2C. As a result of above assembly of the two sections 5 and 6, the conveyor belt 10 gets stretched tight over rollers 11 and 12. In the assembly of FIG. 2C is shown a gap 23 indicated by dotted lines, this gap is between panels 21 and 22 and is covered over by the belt 10. This gap 23 allows the radiation beam 52 to pass vertically from below the belt 10 to above it. Also shown in FIG. 2C is a notch 24 that is a small gap between the top end of rails 13 and 15, it allows the radiation beam 52 to impinge the belt 10 from below and to the side of it as shown in FIGS. 1A and 1B.

FIG. 3 shows the exploded view of panels 31 through 36 and detector boxes 40 and 41.

The system as described above can be easily disassembled into smaller subsystems or parts that can be easily carried and reassembled at the destination location.

In an alternative embodiment, the legs 20 can be long and the x-ray generator 50 can be placed under the conveyor frame and oriented such that the x-ray beam 52 passes through the gap 23 between sections 5 and 6 shown in FIG. 3. The beam 52 after passing through the gap then hits or impinges upon the detector boxes 40 and 41. Further, the detector boxes 40 and 41 could be positioned inside of the tunnel space enclosed by the side and top panels. In such a case, side panels 35 and 36 could be combined into one left side panel; side panels 31 and 32 could be combined into one right side panel; and top panels 33 and 34 could be combined into one top panel.

The side panels 31-36 are shown placed over side rails 13-16 in FIGS. 1A and 1B. However, these side panels could instead be vertically positioned by suitable means on to the ground and to the out sides of the conveyor frame.

The purpose of the inspection tunnel comprising of panels 31-36 is to contain the radiation from spreading outwards and possibly irradiating any humans around. However, for remote operations when there are no humans around at the time x-rays are turned on, then it is not necessary to assemble panels 31-36.

In yet another embodiment, there are no panels 31 through 36 and no detector boxes 40 and 41. Instead the x-ray box 50 includes a back scatter mechanism with a detector that detects the backscattered x-rays to analyze the composition of the package that is placed over the belt 10.

In yet other alternative embodiments, the x-ray source 50 may be replaced by radioactive source, or an electromagnetic source, or a laser or another optical source to interrogate the package.

In yet another embodiment, the box 50 may contain a sniffer which analyzes the air or vapor molecules coming off the surface of package to determine if the contents of the package are explosives or some contraband.

In yet another embodiment, the conveyor system of FIG. 2C may not be used for inspection of packages, but just to build a longer conveyor system comprising of multiple smaller sections.

In yet another alternative embodiment, the conveyor of FIG. 2C may comprise of just one section instead of two sections 5 and 6. Alternatively, there may be more than two sections comprising the conveyor frame.

There are several embodiments possible as would be apparent to a person skilled in the art.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

1. A portable conveyor belt system comprising:
a conveyor frame comprising a first end, a second end, a left side and a right side;
a first roller located at said first end and a second roller located at said second end of said conveyor frame;
a conveyor belt passing over said first and said second rollers;
removable left side panels comprising of at least one panel having a top side and a bottom side, further said bottom side positioned adjacent to said left side of said conveyor frame;
removable right side panels comprising of at least one panel having a top side and a bottom side, further said bottom side positioned adjacent to said right side of said conveyor frame;
removable top side panels comprising of at least one panel having a left side positioned adjacent to said top side of said left side panels, and further having a right side positioned adjacent to said top side of said right side panels; and
a means to drive said conveyor belt over said first and second rollers.

2. The portable conveyor belt of claim 1 wherein said conveyor frame comprises of two or more sections.

3. The portable conveyor belt of claim 1 further comprising:
a radiation source emitting a radiation beam intersecting the space enclosed between said right side panels, said top side panels, said left side panels and said conveyor belt;
a detector to detect said radiation beam; and
an electronic means to analyze signal detected by said detector.

4. The portable conveyor belt of claim 2 further comprising:
a radiation source emitting a radiation beam intersecting the space enclosed between said right side panels, said top side panels, said left side panels and said conveyor belt;
a detector to detect said radiation beam; and
an electronic means to analyze signal detected by said detector.

5. A method of moving an object over a conveyor belt comprising steps:
using a conveyor frame comprising a first end, a second end, a left side and a right side;
using a first roller located at said first end and a second roller located at said second end of said conveyor frame;
passing a conveyor belt over said first and said second rollers;
positioning removable left side panels comprising of at least one panel having a top side and a bottom side, further positioning said bottom side adjacent to said left side of said conveyor frame;
positioning removable right side panels comprising of at least one panel having a top side and a bottom, further positioning said bottom side adjacent to said right side of said conveyor frame;
positioning removable top side panels comprising of at least one panel having a left side positioned adjacent to said top side of said left side panels, and further having a right side positioned adjacent to said top side of said right side panels; and
using a means to drive said conveyor belt over said first and second rollers, thereby moving said object placed over said conveyor belt between said first end and said second end of said conveyor frame.

6. The method of claim 5 wherein the step of using a conveyor frame further includes assembling two or more sections of said conveyor frame.

7. The method of claim 5 further comprising the steps:
using a radiation source emitting a radiation beam intersecting the space enclosed between said right side panels, said top side panels, said left side panels and said conveyor belt;
using a detector to detect said radiation beam; and
using an electronic means to analyze signal detected by said detector.

8. The method of claim 6 further comprising the steps:
using a radiation source emitting a radiation beam intersecting the space enclosed between said right side panels, said top side panels, said left side panels and said conveyor belt;
using a detector to detect said radiation beam; and
using an electronic means to analyze signal detected by detector.
